(19) United States
(12) Patent Application Publication
(10) Pub. No.: US 2007/0211231 A1
(43) Pub. Date: Sep. 13, 2007

(54) EXPOSURE APPARATUS AND DEVICE MANUFACTURING METHOD

(76) Inventor: Hiromi SUDA, Utsunomiya-shi (JP)

Correspondence Address: MORGAN & FINNEGAN, L.L.P., 3 WORLD FINANCIAL CENTER, NEW YORK, NY, 10281-2101, US

(21) Appl. No.: 11/683,035

(22) Filed: Mar. 7, 2007

(30) Foreign Application Priority Data
Mar. 7, 2006 (JP) 2006-060913

(51) Int. Cl. G03B 27/00; G03B 27/42

(52) U.S. Cl. 355/2; 355/53; 355/69

(57) ABSTRACT

An exposure apparatus for exposing a pattern of a reticle onto a substrate includes an illumination optical system configured to illuminate the reticle on a target plane to be illuminated using light from a light source, wherein the illumination optical system includes a computer-generated hologram configured to discretely form plural bright spots on a plane that has a Fourier transformation relationship with the target plane when the light that has no angular distribution is incident upon the computer-generated hologram, and an optical element configured to introduce the light that has an angular distribution to the computer-generated hologram.

### BACKGROUND OF THE INVENTION

The present invention relates to an exposure apparatus and a device manufacturing method.

A conventional projection exposure apparatus projects a circuit pattern of a reticle (mask) onto a wafer via a projection optical system in manufacturing fine devices, such as a semiconductor memory and a logic circuit, using the photolithography technology.

The minimum critical dimension (“CD”) (or a resolution) transferable by the projection exposure apparatus is proportionate to a wavelength of the light used for exposure, and inversely proportionate to the numerical aperture (“NA”) of the projection optical system. The shorter the wavelength is or the higher the NA is, the smaller the resolution is. Hence, along with the recent demand for the fine processing to a semiconductor device, use of a shorter wavelength of the exposure light and a high NA of the projection optical system is promoted. However, use of the shorter wavelength and the high NA has reached its limits to satisfy the demand for the fine processing.

Accordingly, various super-resolution technologies have been proposed. One super-resolution technology is referred to as a modified illumination method (obliquely incident illumination method), which obliquely introduces the illumination light to the reticle. The modified illumination method forms a so-called annular, dipole, or quadrupole light intensity distribution on the pupil plane or Fourier transformation plane to the reticle plane (object plane of the projection optical system). In the projection exposure apparatus that uses a fly-eye lens, the pupil plane for the reticle plane corresponds to an exit plane of the fly-eye lens. The light intensity distribution on the pupil plane for the reticle plane is referred to as an effective light source.

An optical system that converts a light intensity distribution is needed to form the dipole or quadrupole light intensity distribution on the pupil plane for the reticle plane. The simplest optical system that converts the light intensity distribution is an optical system that has an aperture stop with an annular, dipole, or quadrupole shape arranged on the exit plane of the fly-eye lens, which corresponds to the pupil plane. However, the aperture stop partially shields the light from the light source, and thus this optical system cannot effectively utilize the light from the light source, lowering the light intensity on the reticle plane that serves as a target plane to be illuminated, and lowering the throughput. One proposed solution is a method for forming a desired light intensity distribution on the incident plane of the fly-eye lens using a diffraction optical element (“DOE”). See, for example, Japanese Patent Application, Publication No. 2001-284240, 2001-284212, 11-176721, and 2000-150374.

In general, the DOE is designed to form a desired light intensity distribution when receiving the light that has no angular distribution (parallel light). Therefore, in order to form the desired light intensity distribution, it is necessary to introduce the light that has no angular distribution to the DOE.

Nevertheless, the beams are incident at various angular distributions upon the DOE in the projection exposure apparatus. A large DOE is necessary to reduce the spread of the angular distribution in view of the Helmholtz-Lagrange's invariant, and the increased cost and a large switching turret are problematic. Thus, the exposure apparatus that uses the DOE that receives the light having an angular distribution cannot form a desired light intensity distribution on the pupil plane, or has a difficulty in improving the resolution.

### SUMMARY OF THE INVENTION

The present invention is directed to an exposure apparatus that improves the resolution without lowering the throughput, and a device manufacturing method using the same.

An exposure apparatus according to one aspect of the present invention for exposing a pattern of a reticle onto a substrate comprises an illumination optical system configured to illuminate the reticle on a target plane to be illuminated using light from a light source, wherein the illumination optical system includes a computer-generated hologram configured to discretely form plural bright spots on a plane that has a Fourier transformation relationship with the target plane when the light that has no angular distribution is incident upon the computer-generated hologram, and an optical element configured to introduce the light that has an angular distribution to the computer-generated hologram.

A device manufacturing method according to another aspect of the present invention includes the steps of exposing a substrate using the above exposure apparatus, and developing the substrate that has been exposed.

A further object and other characteristics of the present invention will be made clear by the preferred embodiments described below referring to accompanying drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic sectional view of a structure of an exposure apparatus according to one aspect of the present invention.

FIGS. 2A and 2B are views for explaining a conventional DOE.

FIGS. 3A and 3B are views for explaining a DOE in the exposure apparatus shown in FIG. 1.

FIGS. 4A and 4B are views for explaining a variation of the DOE in the exposure apparatus shown in FIG. 1.

FIGS. 5A and 5B are views for explaining another variation of the DOE in the exposure apparatus shown in FIG. 1.

FIG. 6 is a schematic sectional view showing a turret as one illustrative changer that changes a sectional shape of the light incident upon each point of the DOE in the exposure apparatus shown in FIG. 1.

FIG. 7 is a schematic sectional view showing a structure of a fly-eye lens arranged on the turret shown in FIG. 6.

FIGS. 8A and 8B are views for explaining a change of a size of a light intensity pattern formed by the DOE shown in FIGS. 5A and 5B.

FIG. 9 is a schematic sectional view showing one illustrative adjuster that adjusts a divergent angle of the light incident upon the DOE in the exposure apparatus shown in FIG. 1.

FIG. 10 is a flowchart for explaining a manufacture of a device.

FIG. 11 is a flowchart for a wafer process of step 4 shown in FIG. 10.

### DESCRIPTION OF THE EMBODIMENTS

Embodiments of the present invention will now be described in detail in accordance with the accompanying drawings.

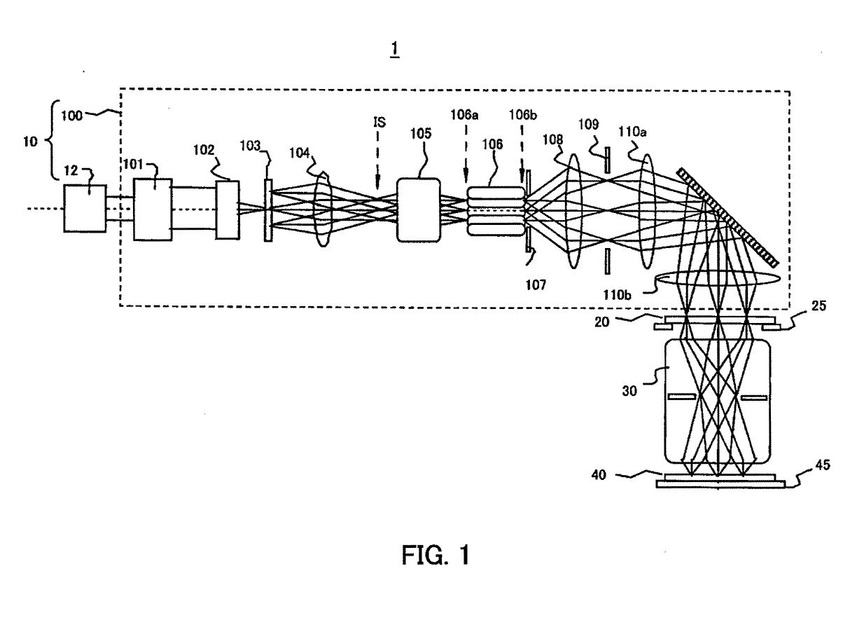

Referring now to the accompanying drawings, a description will be given of an exposure apparatus according to one aspect of the present invention. In each figure, the same reference numeral designates the same element, and a duplicate description thereof will be omitted. Here, FIG. 1 is a schematic block diagram showing a structure of the exposure apparatus 1 according to the present invention.

The exposure apparatus 1 is a projection exposure apparatus that exposes a pattern of a reticle 20 onto a wafer 40 as a substrate. The exposure apparatus 1 of this embodiment is a step-and-scan projection exposure apparatus, but may use a step-and-repeat manner.

The exposure apparatus 1 includes, as shown in FIG. 1, an illumination apparatus 10, a reticle stage 25 mounted with a reticle 20, a projection optical system 30, and a wafer stage 45 mounted with a wafer 40.

The illumination apparatus 10 illuminates the reticle 20, on which a circuit pattern to be transferred is formed, and includes a light source 12 and an illumination optical system 100.

The light source 12 uses an ArF excimer laser with a wavelength of approximately 193 nm. The light source 12 can use a KrF excimer laser with a wavelength of approximately 243 nm, or an F₂ laser with a wavelength of approximately 157 nm. The number of lasers is not limited.

The illumination optical system 100 is an optical system that illuminates the reticle 20, and includes a lens, a mirror, an optical integrator, and a stop. The illumination optical system 100 of this embodiment includes a beam shaping optical system 101, an optical element 102, a DOE 103, a condenser optical system 104, a zooming optical system 105, a multi-beam generator 106, an aperture 107, a collimator lens 108, a stop 109, and imaging optical systems 110a and 110b.

The light emitted from the light source 12 is incident upon the beam shaping optical system 101 that includes a cylindrical lens and a mirror via an optical system that includes a mirror and a relay lens. The beam shaping optical system 101 converts a beam shape of the light into a desired one. The light emitted from the beam shaping optical system 101 is incident upon the optical element 102 that maintains the exit angle.

The light emitted at a desired exit angle from the optical element 102 is introduced to the DOE 103. The exit plane of the DOE 103 and a target plane IS to be illuminated have a Fourier transformation relationship by the condenser optical system 104. The condenser optical system 104 condenses the light emitted from the DOE 103. The target plane to be illuminated is located near a position at which the effective light source is formed, and also has a Fourier transformation relationship with the reticle.

This embodiment can always control the incident position and the divergent angle (or convergent angle) of the light incident upon the DOE 103 to a desired value even when the light from the light source 12 minutely fluctuates. Thereby, the light intensity distribution formed at a position of the target plane IS can be always maintained constant.

The DOE 103 is a computer-generated hologram (“CGH”) designed to form a desired light intensity distribution, such as a dipole or quadrupole shape, on a position of the target plane IS via the condenser optical system 104. The DOE 103 of this embodiment uses a amplitude distribution type hologram, a phase distribution type hologram, or a kinoform.

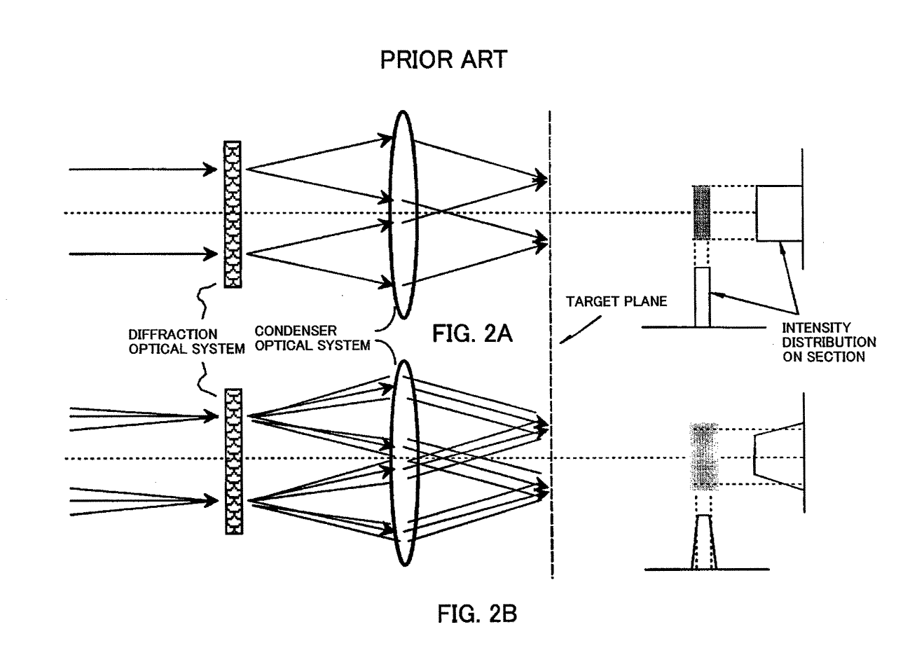

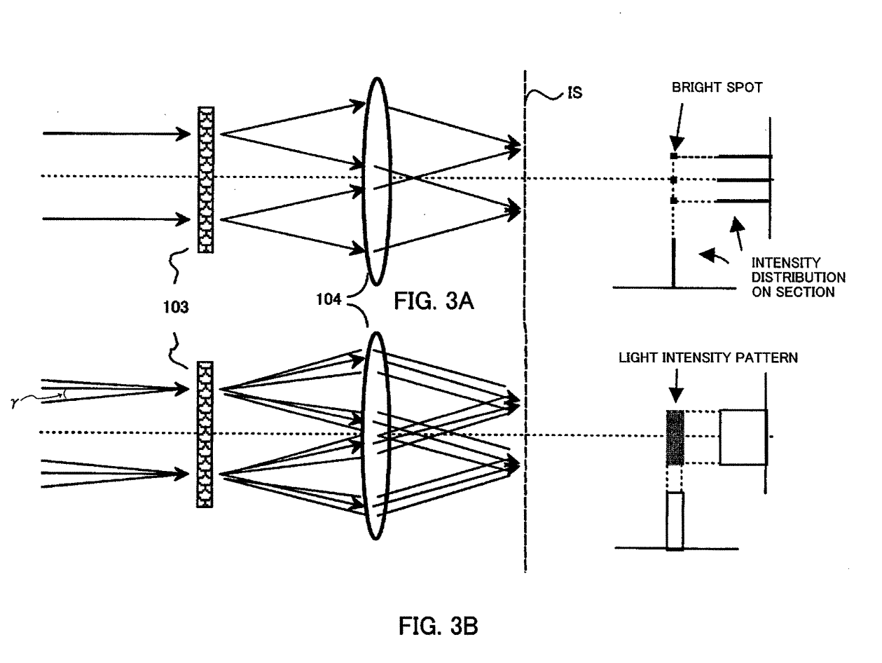

Referring now to FIGS. 2A to 3B, a detailed description will be given of the DOE 103 of this embodiment. FIGS. 2A and 2B are views for explaining a conventional DOE. FIG. 2A is a schematic sectional view of the DOE that receives the parallel light, and the light intensity pattern formed by that DOE on the target plane. FIG. 2B is a schematic sectional view of the DOE that receives the light having an angular distribution, and the light intensity pattern formed by that DOE on the target plane. The angular distribution is a distribution of an angle of the light incident upon each point of the DOE. FIGS. 3A and 3B are views for explaining the DOE 103 in this embodiment. FIG. 3A is a schematic sectional view of the DOE 103 that receives the parallel light, and the light intensity pattern formed by that DOE 103 on the target plane. FIG. 3B is a schematic sectional view of the DOE 103 that receives the light having an angular distribution, and the light intensity pattern formed by that DOE 103 on the target plane.

In general, the conventional DOE forms an intended rectangular light intensity pattern on the target plane when receiving the parallel light, as shown in FIG. 2A. When the conventional DOE receives the light having an angular distribution (which is a uniformly rectangular shape in this embodiment), a direction of the diffracted light differs in accordance with an incident light angle, forming a rectangular light intensity pattern for each angle of the incident light. Therefore, the light intensity pattern that superposes the rectangular light intensity pattern generated for each angle is formed on the target plane, as shown in FIG. 2B, and the effective light source has a blurred image unlike the incidence of the parallel light.

On the other hand, the DOE of this embodiment is designed to form one or more infinitesimal bright spots at regular intervals or discretely on the target plane IS, as shown in FIG. 3A, when receiving the parallel light. When the light having a uniformly rectangular angular distribution is incident upon the DOE 103, the DOE 103 forms an intended rectangular light intensity pattern on the target plane IS for each bright spot. One bright spot forms a rectangular light intensity pattern with a size of 2×f×tan γ on the target plane IS, where γ is a divergent (or convergent) angle of the light incident upon the DOE 103 (as shown in FIG. 3B), and f is a focal length of the condenser optical system 104. Therefore, when the minimum interval of the bright spots is set to 2×f×tan γ, the adjacent light intensity patterns do not superimpose to each other. When the bright point is arranged at regular intervals of 2×f×tan γ, the intended light intensity pattern is obtained on the target plane IS as shown in FIG. 3B. The intended light intensity pattern is a uniform light intensity at each distribution, as shown in FIG. 3B.

The DOE 103 that forms plural bright spots on the target plane IS when receiving the parallel light can form an intended light intensity pattern without blurring the light intensity pattern even when the DOE 103 receives the light having an angular distribution.

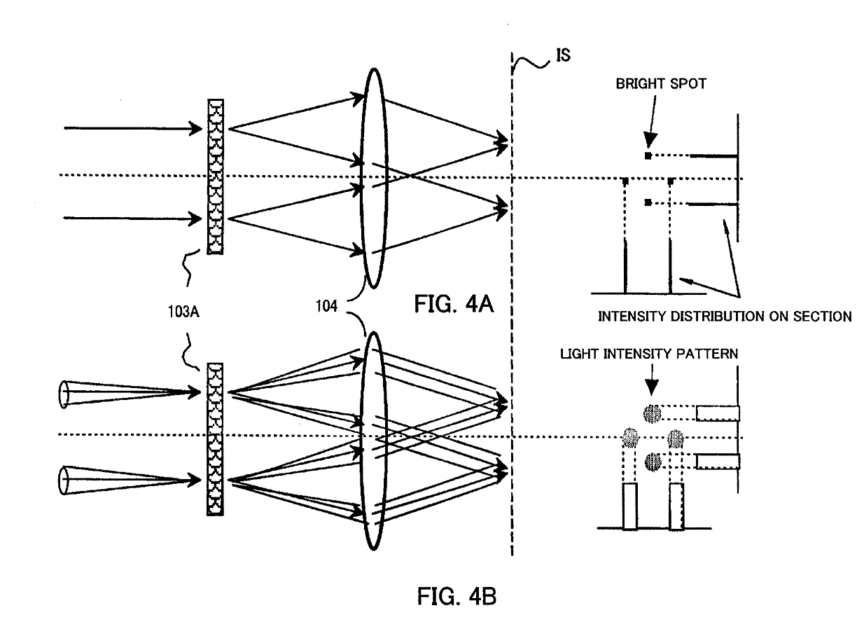

A shape of the angular distribution of the light incident upon each point of the DOE (or the sectional shape of the light incident upon each point of the DOE 103 on the plane perpendicular to the optical axis of the illumination optical system 100) can be turned, for example, into a uniform circle, rectangle or hexagon. A DOE 103A may be designed to form bright points shown in FIG. 4A on the target plane IS when receiving the parallel light, and the light having a circularly angular distribution may be incident upon the DOE 103A. In this case, as shown in FIG. 4B, the quadrupole illumination may be formed on the target plane IS. The light intensity pattern formed on the target plane IS can further form another pattern (or distribution) via a beam splitter (not shown) that is located near the target plane IS. FIGS. 4A and 4B are views for explaining the DOE 103A as a variation of the DOE 103.

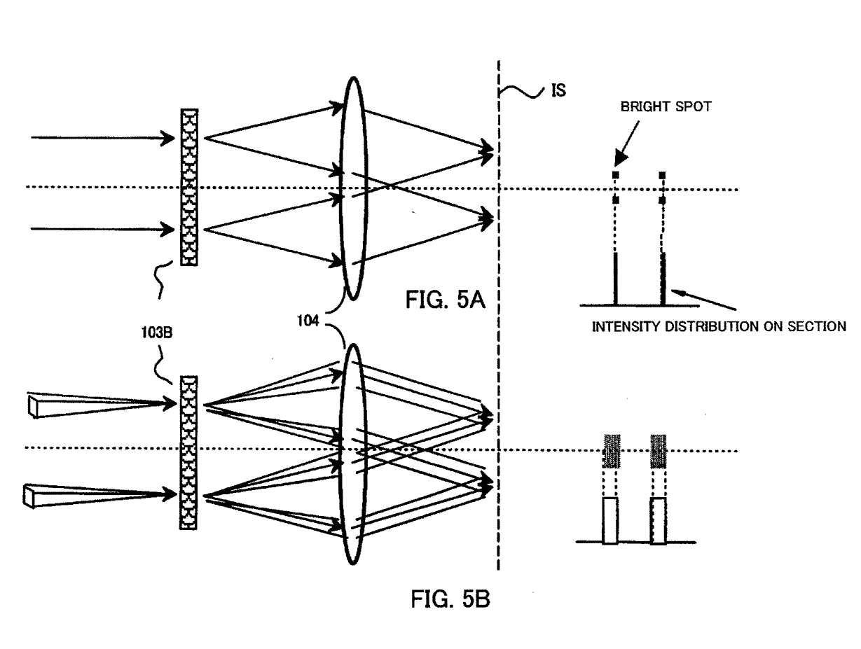

A DOE 103B may be designed to form bright points shown in FIG. 5A on the target plane IS when receiving the parallel light, and the light having a rectangular sectional shape may be incident upon the DOE 103B. In this case, as shown in FIG. 5B, a combination of plural bright spots can closely form a continuous light intensity pattern The light having a rectangular sectional shape means that the light incident upon each point of the DOE 103B has a rectangular sectional shape on the plane perpendicular to the optical axis of the illumination optical system 100. Here, FIGS. 5A and 5B are views for explaining the DOE 103B as a variation of the DOE 103.

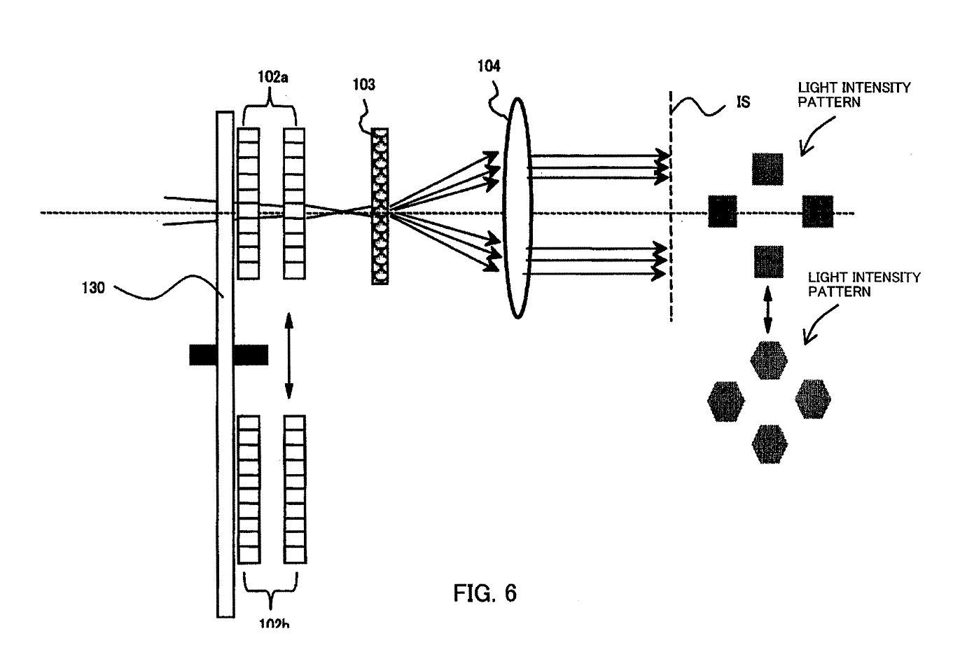

In changing the angular distribution of the light incident upon each point of the DOE 103, for example, from a rectangular sectional shape to a hexagonal shape, the turret 130 shown in FIG. 6 may be used. Here, FIG. 6 is a schematic sectional view of the turret 130 as one illustrative changer that changes an angular distribution of the light incident upon each point of the DOE 103.

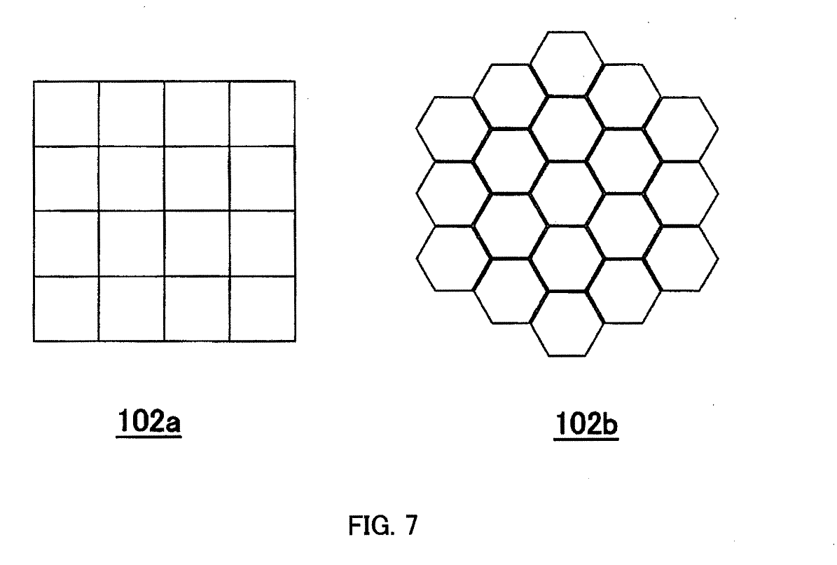

The turret 130 is mounted with a fly-eye lens 102a that includes plural fine lenses each having a rectangular sectional shape, and a fly-eye lens 102b that includes plural fine lenses each having a hexagonal sectional shape. When the turret 130 rotates to arrange one of the fly-eye lenses 102a and 102b on the optical path of the illumination optical system 100. In accordance with the incident light's angular distribution, the DOE 103 may be switched. In this case, similarly, a rotatable turret may be mounted, for example, with the DOEs 103, 103A and 103B. Here, FIG. 7 is a schematic sectional view showing a structure of the fly-eye lenses 102a and 102b arranged on the turret 130 shown in FIG. 6.

While this embodiment uses the fly-eye lenses 102a and 102b that includes two lens arrays for the optical element 102, the fine lens in the fly-eye lens 102a and 102b may be a DOE. Alternatively, the fly-eye lenses 102a and 102b may use a micro lens array.

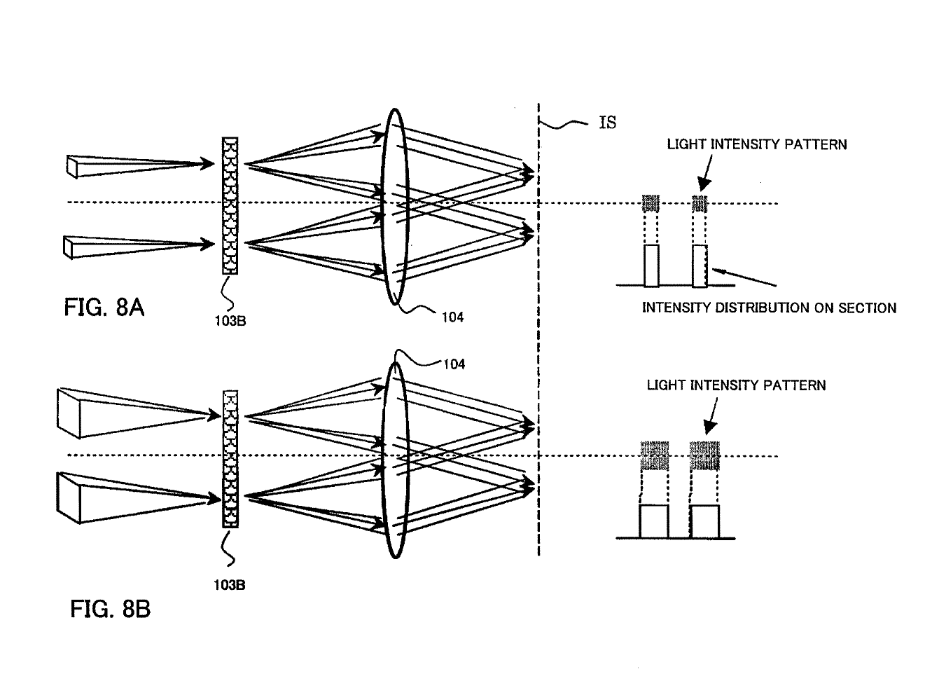

When the angular distribution of the light incident upon the DOE 103B is made variable (or when the divergent angle of the light incident upon each point of the DOE 103B is adjusted), as shown in FIG. 8, the light intensity pattern formed on the target plane IS has a variable size. This is effective to fine adjustments in forming the continuous light intensity pattern by connecting adjacent light intensity patterns using the DOE 103B that forms plural bright spots as shown in FIGS. 5A and 5B. Here, FIG. 8 is a view for explaining a size of the light intensity pattern formed by the DOE 103B.

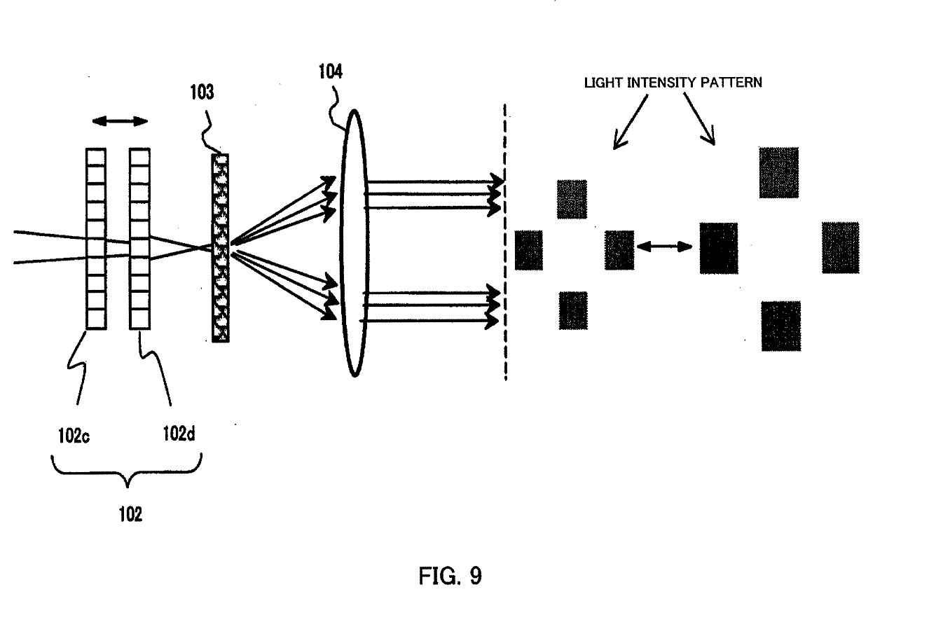

In order to change the size of the light intensity pattern formed by the DOE 103, the optical element 102 as a fly-eye lens may include at least two lens arrays 102c and 102d, as shown in FIG. 9. An interval between the lens arrays 102c and 102d is made adjustable in the optical-axis direction of the illumination optical system. As the interval varies, the angular distribution of the light incident upon the DOE 103 changes and the size of the light intensity pattern formed by the DOE 103 changes as shown in FIG. 9. Alternatively, the light intensity pattern formed by the DOE 103 may be adjusted with a zooming optical system by composing the condenser optical system 104 of the zooming optical system that can adjust the focal length. Here, FIG. 9 is a schematic sectional view showing one illustrative structure of the adjuster that adjusts the divergent angle of the light incident upon each pint on the DOE 103.

Thus, the illumination optical system 100 can realize various illumination modes, such as a dipole illumination and a quadrupole illumination, by switching the DOE 103, by switching or adjusting a position of the optical element 102, and by adjusting a focal length of the condenser optical system 104.

Turning back to FIG. 1, the zooming optical system 105 projects or forms an image of the light intensity pattern on the target plane IS, onto the light incident plane 106a of the multi-beam generator 106 at various magnifications. The multi-beam generator 106 forms a light source image corresponding to the light intensity pattern image of the uniform light intensity distribution on a light exit plane 106b.

The multi-beam generator 106 of this embodiment is a fly-eye lens that includes plural fine lenses or a fiber bundle. The plane light source that includes plural point light sources is formed on a light exit plane 106b. The fine lens in the fly-eye lens may be replaced with a DOE or a micro lens array.

The aperture 107 shields the light source image formed on the light exit plane 106b of the light generator 106, and forms a desired light source image. The collimator lens 108 forms a secondary light source having multiple condensing points formed by the multi-beam generator 106, and uniformly illuminates the reticle 20.

The stop 109 defines an illumination area on the target plane IS. The collimator lens 108 illuminates the stop 109 with a uniform light intensity distribution using the secondary light source as the condensing point of the multi-beam generator 106.

The imaging optical systems 110a and 110b have an object plane at the position of the stop 109, and an image plane at the position of the reticle 20. The uniform light intensity distribution realized at the position of the stop 109 is projected onto the reticle 20, illuminating the reticle 20 with a uniform light intensity.

The reticle 20 is made of quartz, has a circuit pattern to be transferred, and is supported and driven by the reticle stage 25. The reticle stage 25 supports the reticle 20, and is connected to a moving mechanism (not shown).

The projection optical system 30 projects an image of the pattern of the reticle 20 onto the wafer 40. The projection optical system 30 can use a dioptric, catadioptric, or catoptric system.

This embodiment uses a wafer for the substrate, but the substrate may be a liquid crystal substrate and a glass plate. A photoresist is applied to the surface of the wafer 40.

The wafer stage 45 supports the wafer 40.

In exposure, the light is emitted from the light source 12 illuminates the reticle 20 via the illumination optical system 14. The light that has passed the reticle and reflected the reticle pattern is imaged onto the wafer 40 via the projection optical system 30. The illumination optical system 100 in the exposure apparatus 1 uses the DOE 103, and forms a desired light intensity distribution even when receiving the light having an angular distribution. Thereby, the exposure apparatus 1 can improve the resolution without lowering the throughput. Thus, the exposure apparatus 1 can provide higher quality devices, such as semiconductor devices and LCD devices, with high throughput and economic efficiency than ever.

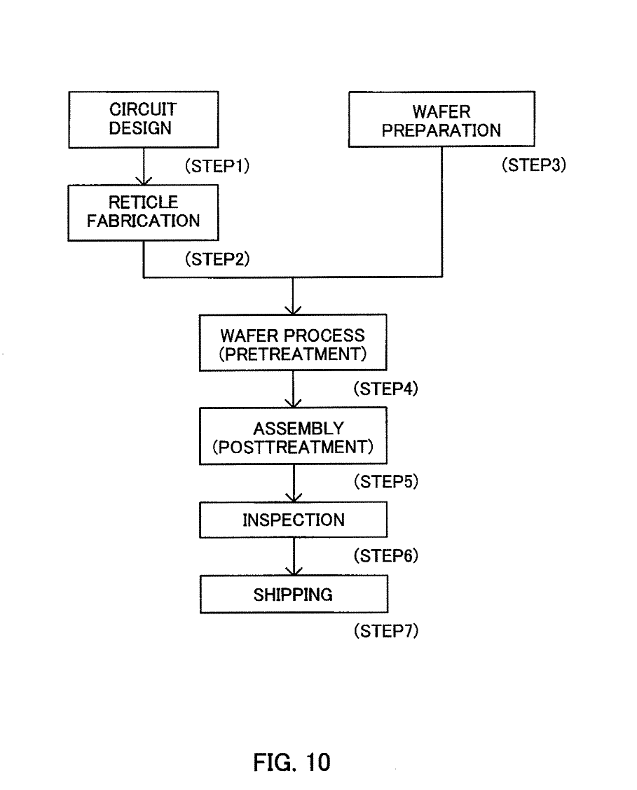

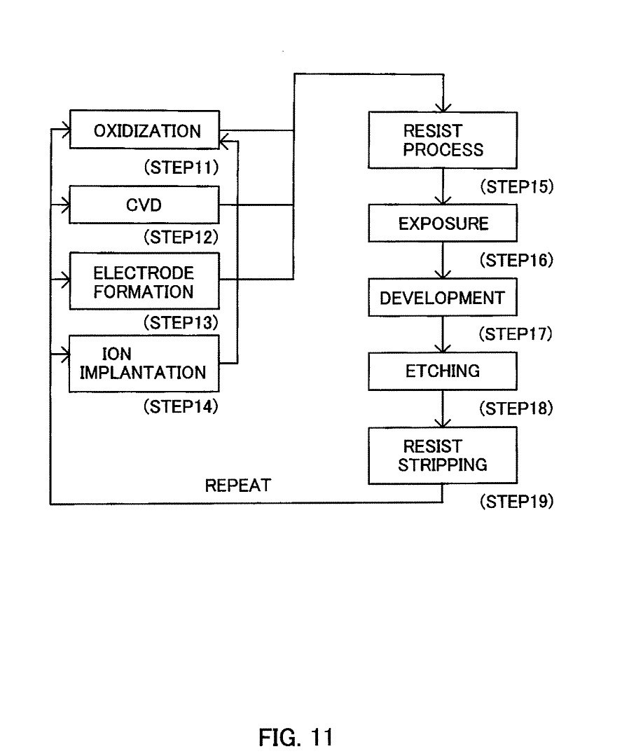

Referring now to FIGS. 10 and 11, a description will be given of an embodiment of a device manufacturing method using the exposure apparatus 1. FIG. 10 is a flowchart for explaining how to fabricate devices, such as a semiconductor device and a LCD device. Here, a description will be given of the fabrication of a semiconductor device as an example. Step 1 (circuit design) designs a semiconductor device circuit. Step 2 (reticle fabrication) forms a reticle having a designed circuit pattern. Step 3 (wafer preparation) manufactures a wafer using materials such as silicon. Step 4 (wafer process), which is also referred to as a pretreatment, forms the actual circuitry on the wafer through lithography using the reticle and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests on the semiconductor device made in Step 5, such as a validity test and a durability test. Through these steps, a semiconductor device is finished and shipped (Step 7).

FIG. 11 is a detailed flowchart of the wafer process in Step 4. Step 11 (oxidation) oxidizes the wafer's surface. Step 12 (CVD) forms an insulating layer on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 1 to expose a circuit pattern of the reticle onto the wafer. Step 17 (development) develops the exposed wafer. Step 18 (etching) etches parts other than a developed resist image. Step 19 (resist stripping) removes unused resist after etching. These steps are repeated to form multi-layer circuit patterns on the wafer. The device manufacturing method of this embodiment may manufacture higher quality devices than ever. Thus, the above device manufacturing method can provide a higher quality device than ever. Thus, the device manufacturing method using the exposure apparatus 1, and resultant devices constitute one aspect of the present invention.

The entire disclosure of Japanese Patent Application No. 2006-060913, filed on Mar. 7, 2007, including claims, specification, drawings and abstract incorporated herein by reference in its entirety.

As many apparently widely different embodiments of the present invention can be made without departing from the sprit and scope thereof, it is to be understood that the invention is not limited to the specific embodiments thereof except as defined in the claims.

What is claimed:

1. An exposure apparatus for exposing a pattern of a reticle onto a substrate, the exposure apparatus comprising an illumination optical system configured to illuminate the reticle on a target plane to be illuminated using light from a light source, wherein the illumination optical system includes:
a computer-generated hologram configured to discretely form plural bright spots on a plane that has a Fourier transformation relationship with the target plane when the light that has no angular distribution is incident upon the computer-generated hologram; and
an optical element configured to introduce the light that has an angular distribution to the computer-generated hologram.

2. An exposure apparatus according to claim 1, wherein when the optical element introduces the light having the angular distribution to the computer-generated hologram, a light intensity distribution on the plane that has the Fourier transformation relationship with the target plane becomes uniform.

3. An exposure apparatus according to claim 1, wherein the illumination optical system further includes a condenser optical system configured to condense the light from the computer-generated hologram, wherein the condenser optical system has a variable focal length.

4. An exposure apparatus according to claim 1, wherein the illumination optical system further includes a condenser optical system configured to condense the light from the computer-generated hologram, wherein d=2×f×tan γ is met where d is a minimum interval in the plural bright spots, γ is a divergent angle of the light incident upon the computer-generated hologram, and f is a focal length of the condenser optical system.

5. An exposure apparatus according to claim 1, wherein the illumination optical system further includes a changer configured to change a sectional shape of the light incident upon the computer-generated hologram with respect to a plane perpendicular to an optical axis of the illumination optical system.

6. An exposure apparatus according to claim 5, wherein the sectional shape is one of a circle, a rectangle, and a hexagon.

7. An exposure apparatus according to claim 1, wherein the illumination optical system further includes an adjuster configured to adjust a divergent angle of the light incident upon the computer-generated hologram.

8. An exposure apparatus according to claim 2, wherein the light intensity distribution has a multipole distribution.

9. An exposure apparatus according to claim 2, wherein the light intensity distribution is a continuous distribution that connects two adjacent light intensity distributions corresponding to two adjacent bright spots.

10. A device manufacturing method comprising the steps of:
exposing a substrate using an exposure apparatus; and
developing the substrate that has been exposed, wherein the exposure apparatus includes an illumination optical system configured to illuminate the reticle on a target plane to be illuminated using light from a light source, wherein the illumination optical system includes:
a computer-generated hologram configured to discretely form plural bright spots on a plane that has a Fourier transformation relationship with the target plane when the light that has no angular distribution is incident upon the computer-generated hologram; and
an optical element configured to introduce the light that has an angular distribution to the computer-generated hologram.
